(19) United States
(12) Patent Application Publication
(10) Pub. No.: US 2025/0182532 A1
(43) Pub. Date: Jun. 5, 2025

(54) IMAGE PROCESSING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Yingyi ZHANG, Shenzhen (CN); Ruixin ZHANG, Shenzhen (CN); Lei SHEN, Shenzhen (CN); Shouhong DING, Shenzhen (CN); Shaoming WANG, Shenzhen (CN)

(73) Assignee: Tencent Technology (Shenzhen) Company Limited, Shenzhen (CN)

(21) Appl. No.: 19/052,491

(22) Filed: Feb. 13, 2025

Related U.S. Application Data
(63) Continuation of application No. PCT/CN2023/129968, filed on Nov. 6, 2023.

(30) Foreign Application Priority Data
Feb. 13, 2023 (CN) 202310139769.0

(51) Int. Cl. G06V 40/40; G06T 7/571; G06T 7/73; G06V 40/12; G06V 40/50

(52) U.S. Cl. CPC G06V 40/45; G06T 7/571; G06T 7/73; G06V 40/1347; G06V 40/1365; G06V 40/50; G06T 2207/10148; G06T 2207/30196

(57) ABSTRACT

An image processing method includes obtaining a photographed image by photographing a biological object in a living-body detection scenario, and a background; performing depth-of-field analysis on the photographed image, to obtain first depth-of-field information of the biological object and second depth-of-field information of the background; comparing the first depth-of-field information with the second depth-of-field information, to obtain a comparison result; determining, based on the comparison result, a living-body detection result indicating whether the biological object in the living-body detection scenario is a real living object; and performing at least one of storing the photographed image into a biological registry if the living-body detection result of the biological object indicates a living-body detection success; or extracting a biometric feature of the biological object in the photographed image and storing the biometric feature into the biological registry, if the living-body detection result of the biological object indicates the living-body detection success.

### CROSS-REFERENCE TO RELATED APPLICATIONS

This application is a continuation application of International Application No. PCT/CN2023/129968 filed on Nov. 6, 2023, which claims priority to Chinese Patent Application No. 202310139769.0 filed with the China National Intellectual Property Administration on Feb. 13, 2023, the disclosures of each being incorporated by reference herein in their entireties.

### FIELD

The disclosure relates to the field of computer technologies, to the field of living-body detection technologies, and to an image processing method and apparatus, an electronic device, a computer-readable storage medium, and a computer program product.

### BACKGROUND

With rapid development of computer technologies, living-body detection technologies are widely applied to related service scenarios (that is, living-body detection scenarios) that may use identity authentication. For example, living-body detection may be used in scenarios such as biometric payment and biometric unlocking. The living-body detection technology may be configured for detecting whether a biological object in a living-body detection scenario is a real living object. For example, the living-body detection technology may be configured for detecting whether a biological object currently undergoing biometric payment is a real living object, or the living-body detection technology may be configured for detecting whether a biological object currently undergoing biometric unlocking is a real living object.

Living-body detection technology may be susceptible to video playback attacks. The video playback attack refers to an illegal means of replacing a real living object with a recorded video of the real living object to perform living-body detection in a living-body detection process. The living object in the recorded video can complete corresponding actions according to requirements of the living-body detection. The video playback attack can pass the living-body detection to some extent. The accuracy of existing living-body detection methods may be inadequate.

### SUMMARY

Provided are an image processing method and apparatus, an electronic device, a computer-readable storage medium, and a computer program product, which are capable of mitigating a video playback attack during living-body detection.

According to an aspect of the disclosure, an image processing method, performed by an electronic device, includes obtaining a photographed image by photographing a biological object to be detected in a living-body detection scenario, and a background of the biological object; performing depth-of-field analysis on the photographed image, to obtain first depth-of-field information of the biological object and second depth-of-field information of the background; comparing the first depth-of-field information with the second depth-of-field information, to obtain a comparison result; determining, based on the comparison result, a living-body detection result indicating whether the biological object in the living-body detection scenario is a real living object; and performing at least one of storing the photographed image into a biological registry if the living-body detection result of the biological object indicates a living-body detection success; or extracting a biometric feature of the biological object in the photographed image and storing the biometric feature into the biological registry, if the living-body detection result of the biological object indicates the living-body detection success.

According to an aspect of the disclosure, an image processing apparatus includes at least one memory configured to store computer program code; and at least one processor configured to read the program code and operate as instructed by the program code, the program code including obtaining code configured to cause at least one of the at least one processor to photograph a biological object to be detected in a living-body detection scenario, and a background of the biological object to obtain a photographed image; and first processing code configured to cause at least one of the at least one processor to perform depth-of-field analysis on the photographed image, to obtain first depth-of-field information of the biological object and second depth-of-field information of the background; second processing code configured to cause at least one of the at least one processor to compare the first depth-of-field information with the second depth-of-field information, to obtain a comparison result; third processing code configured to cause at least one of the at least one processor to determine, based on the comparison result, a living-body detection result indicating whether the biological object in the living-body detection scenario is a real living object; and registry code configured to cause at least one of the at least one processor to perform at least one of store the photographed image into a biological registry if the living-body detection result of the biological object indicates a living-body detection success; or extract a biometric feature of the biological object in the photographed image and storing the biometric feature into the biological registry, if the living-body detection result of the biological object indicates the living-body detection success.

According to an aspect of the disclosure, a non-transitory computer-readable storage medium, storing computer code which, when executed by at least one processor, causes the at least one processor to at least photograph a biological object to be detected in a living-body detection scenario, and a background of the biological object to obtain a photographed image; and perform depth-of-field analysis on the photographed image, to obtain first depth-of-field information of the biological object and second depth-of-field information of the background; compare the first depth-of-field information with the second depth-of-field information, to obtain a comparison result; determine, based on the comparison result, a living-body detection result indicating whether the biological object in the living-body detection scenario is a real living object; and perform at least one of store the photographed image into a biological registry if the living-body detection result of the biological object indicates a living-body detection success; or extract a biometric feature of the biological object in the photographed image and storing the biometric feature into the biological registry, if the living-body detection result of the biological object indicates the living-body detection success.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1A is a schematic diagram of a living-body detection scenario according to some embodiments.

FIG. 1B is a schematic diagram of another living-body detection scenario according to some embodiments.

FIG. 2A is a schematic diagram of an architecture of an image processing system according to some embodiments.

FIG. 2B is a schematic application diagram of a living-body detection scenario according to some embodiments.

FIG. 3 is a schematic flowchart of an image processing method according to some embodiments.

FIG. 4 is a schematic diagram of image pre-processing according to some embodiments.

FIG. 5 is a schematic diagram of a skeleton analysis result according to some embodiments.

FIG. 6 is a schematic diagram of a manner of determining a biological region image according to some embodiments.

FIG. 7 is a schematic diagram of another manner of determining a biological region image according to some embodiments.

FIG. 8 is a schematic diagram of another manner of determining a biological region image according to some embodiments.

FIG. 9 is a schematic diagram of a manner of determining a background region image according to some embodiments.

FIG. 10 is a schematic diagram of another manner of determining a background region image according to some embodiments.

FIG. 11 is a schematic diagram of a manner of calculating image blurriness according to some embodiments.

FIG. 12 is a schematic flowchart of another image processing method according to some embodiments.

FIG. 13 is a schematic structural diagram of an image processing apparatus according to some embodiments.

FIG. 14 is a schematic structural diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

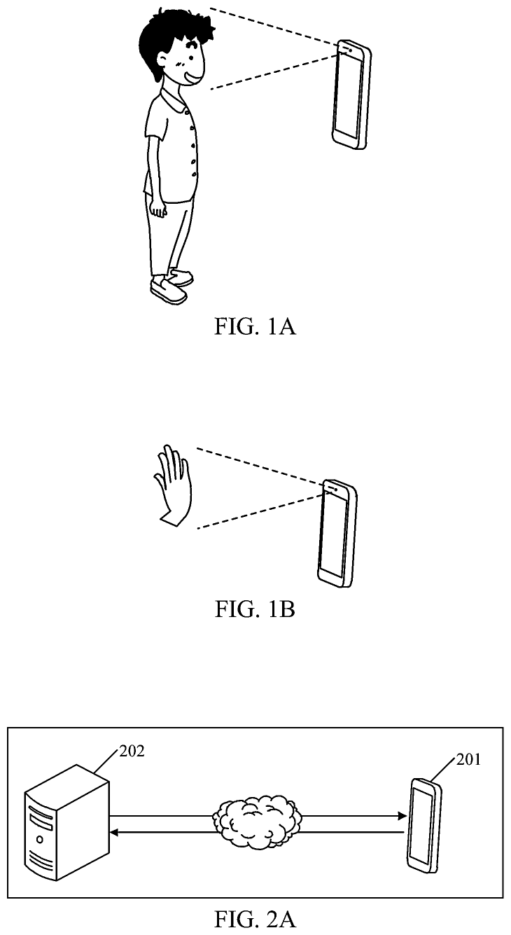

A living-body detection technology refers to a technology configured for detecting whether a biological object in a living-body detection scenario is a real living object in some identity authentication related service scenarios (that is, living-body detection scenarios such as biometric payment and biometric unlocking scenarios), for example, configured for detecting whether a biological object currently undergoing biometric payment is a real living object, or configured for detecting whether a biological object currently undergoing biometric unlocking is a real living object. The biological object may include but is not limited to: a human face, a hand, a fingerprint, an iris, and the like. For example, FIG. 1A is a schematic diagram of a scenario of performing living-body detection on a human face, and FIG. 1B is a schematic diagram of a scenario of performing living-body detection on a hand.

The living-body detection technology is susceptible to video playback attacks. The video playback attack refers to an illegal means of replacing a real living object with a recorded video of the real living object to perform living-body detection in a living-body detection process. The living object in the recorded video can complete corresponding actions according to requirements of the living-body detection. The video playback attack can pass the living-body detection to some extent. Research found that there is vulnerability in the video playback attack, The vulnerability may be that the video playback attack may be played by a device with a screen. During the video playback attack, for a photographing device, a currently photographed biological object and a background of the biological object are located in a same plane, and a distance between the biological object and the photographing device is the same as a distance between the background and the photographing device. In a living-body detection process, to enable the photographing device to clearly photograph the biological object, a distance between the biological object and the photographing device is relatively short. For the photographing device, a distance between the biological object and the photographing device is relatively short, a distance between the background and the photographing device is relatively long, and the currently photographed biological object and the background of the biological object are not in a same plane.

Based on this, some embodiments provide an image processing method. According to the image processing method, after a photographed image is obtained by photographing a to-be-detected biological object in a living-body detection scenario and a background of the biological object, depth-of-field analysis is performed on the photographed image, so that depth-of-field information of the biological object that indicates a distance between the biological object and a photographing device can be obtained, and depth-of-field information of the background that indicates a distance between the background and the photographing device can be obtained. Through comparison between the depth-of-field information of the biological object and the depth-of-field information of the background, it can be determined whether the distance between the biological object and the photographing device is the same as the distance between the background and the photographing device, and it can be determined whether the currently photographed biological object and the background of the biological object are located in a same plane. This can determine whether a living-body detection process suffers a video playback attack. Based on the image processing method provided in some embodiments, a video playback attack during living-body detection can be effectively resisted, thereby improving accuracy of the living-body detection.

The image processing method provided in some embodiments may relate to technologies such as machine learning (ML) and computer vision (CV) in the field of artificial intelligence (AI) in a process of performing depth-of-field analysis on a photographed image.

AI is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making. The AI technology is a comprehensive discipline, and relates to a wide range of fields including both hardware-level technologies and software-level technologies.

ML is a multi-field interdiscipline, and relates to a plurality of disciplines such as the probability theory, statistics, the approximation theory, convex analysis, and the algorithm complexity theory. ML involves studying how a computer simulates or implements a human learning behavior to obtain new knowledge or skills, and reorganize an existing knowledge structure, to keep improving its performance. ML is the core of AI, is a basic way to make the computer intelligent, and is applied to various fields of AI. ML and deep learning include technologies such as an artificial neural network, a belief network, reinforcement learning, transfer learning, inductive learning, and learning from demonstrations.

The CV technology is a science that studies how to make a machine “see”. The CV technology refers to using a camera and a computer to replace human eyes to perform machine vision such as recognition and measurement on a target, and further perform graphics processing, so that the computer processes an image that is more for human eyes to observe or transmit the image to an instrument for detection. As a scientific discipline, CV studies related theories and technologies and attempts to establish an AI system that can obtain information from images or multidimensional data. The CV technology involves technologies such as image processing, image recognition, image semantic understanding, image retrieval, optical character recognition (OCR), video processing, video semantic understanding, video content/behavioral recognition, three-dimensional (3D) object reconstruction, a 3D technology, virtual reality, augmented reality, simultaneous localization and mapping, and further include common biometric recognition technologies such as face recognition and fingerprint recognition, and living-body detection technology.

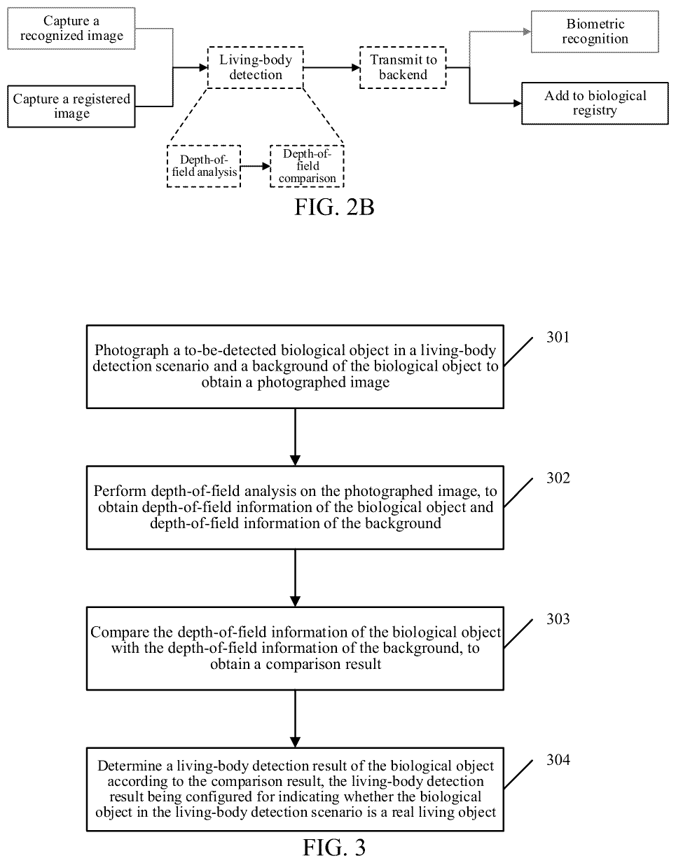

An image processing system for implementing the image processing method according to some embodiments is described below with reference to FIG. 2A.

As shown in FIG. 2A, the image processing system may include a photographing device 201 and an image processing device 202. The photographing device 201 may be configured to photograph a to-be-detected biological object in a living-body detection scenario and a background of the biological object, to obtain a photographed image of the biological object. The image processing device 202 may be configured to perform depth-of-field analysis on the photographed image, compare depth-of-field information of the biological object and depth-of-field information of the background in a depth-of-field analysis result, and determine a living-body detection result of the biological object according to a comparison result.

The photographing device 201 may be a terminal device including a camera having a focal length adjustment function. The terminal device may be any one of, but is not limited to, a smartphone, a tablet computer, a laptop computer, a desktop computer, an intelligent voice interaction device, a smart watch, an on-board terminal, a smart home appliance, an aircraft, a camera, and a video camera. The image processing device 202 may be a terminal device or a server. The terminal device may be any one of, but is not limited to, a smartphone, a tablet computer, a laptop computer, a desktop computer, an intelligent voice interaction device, a smart watch, an on-board terminal, a smart home appliance, and an aircraft. The server may be an independent physical server, or may be a server cluster or a distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and AI platform. The disclosure is not limited thereto.

Some embodiments shown in FIG. 2A is described by using an example in which the photographing device 201 and the image processing device 202 are integrated into different devices. For example, the photographing device 201 may be a smartphone including a camera with a focal length adjustment function, and the image processing device 202 may be a server. When the photographing device 201 and the image processing device 202 are integrated into different devices, a direct communication connection may be established between the photographing device 201 and the image processing device 202 in a wired communication protocol, or an indirect communication connection may be established between the photographing device 201 and the image processing device 202 in a wireless communication protocol. The disclosure is not limited thereto. The photographing device 201 and the image processing device 202 may be integrated into a same device. For example, the photographing device 201 and the image processing device 202 may both be a smartphone including a camera with a focal length adjustment function.

The image processing system described in some embodiments is intended to describe the technical solutions in some embodiments more clearly, and does not constitute a limitation on the technical solutions provided in some embodiments. A person of ordinary skill in the art may learn that, with evolution of a system architecture and emergence of new service scenarios, the technical solutions provided in some embodiments are also applicable to similar technical problems.

Based on the image processing system shown in FIG. 2A, living-body detection of a biological object may be used as a fronted security verification procedure in scenarios such as biometric payment (for example, a payment scenario, a ride scenario, or other scenarios) and biometric unlocking (for example, release of access control), for example, may be used as a fronted security verification procedure of registration, or a fronted security verification procedure of biometric recognition.

As shown in a flowchart consisting of black solid-line boxes and black dashed-line boxes in FIG. 2B, living-body detection of a biological object may be used as a fronted security verification procedure of registration: The living-body detection may be performed on the biological object based on a photographed image (registered image) of the biological object. If a living-body detection result of the biological object indicates a living-body detection success, the photographed image may be stored into a biological registry, to complete registration. If a living-body detection result of the biological object indicates a living-body detection success, biometric features of the biological object in the photographed image may be extracted, and the biometric features are stored into a biological registry, to complete registration. If the living-body detection result of the biological object indicates a living-body detection failure, the registration fails. Using living-body detection of a biological object as a fronted security verification procedure of registration can improve security of the registration procedure and prevent the registration procedure from suffering an illegal video playback attack.

As shown in a flowchart consisting of gray solid-line boxes and black dashed-line boxes in FIG. 2B, living-body detection of a biological object may be used as a fronted security verification procedure of biometric recognition: Biometric recognition may be configured for recognizing whether a currently photographed recognized image (or a biometric feature extracted from the recognized image) of a biological object matches a registered image (or a biometric feature extracted from the registered image) when the biological object is registered. Living-body detection may be performed on the biological object based on a photographed image (recognized image) of the biological object. If a living-body detection result of the biological object indicates a living-body detection success, matching detection may be performed on the photographed image and registered images in a biological registry, and when the registered image of the biological object that matches the photographed image is successfully detected, it may be determined that authentication on the biological object succeeds, biometric recognition succeeds, and the biological object may perform a subsequent payment action, or access control may be released for the biological object. If a living-body detection result of the biological object indicates a living-body detection success, matching detection may be performed on a biometric feature of the biological object in the photographed image with registered biometric features in a biological registry, and when a registered biometric feature of the biological object that matches the biometric feature of the biological object in the photographed image is successfully detected, it may be determined that authentication on the biological object succeeds, biometric recognition succeeds, and the biological object may perform a subsequent payment action, or access control may be released for the biological object. If the living-body detection result of the biological object indicates a living-body detection failure, the biometric recognition fails. Using living-body detection of a biological object as a fronted security verification procedure of biometric recognition can improve security of the biometric recognition procedure and prevent the biometric recognition procedure from suffering an illegal video playback attack.

Some embodiments involve collecting relevant data such as images or videos of biological objects. When some embodiments are applied to products or technologies, the permission or consent of the biological objects should be obtained, and the collection, use, and processing of relevant data should comply with the relevant laws, regulations, and standards of the relevant countries and regions.

The image processing method according to some embodiments is described in more detail below with reference to the accompanying drawings.

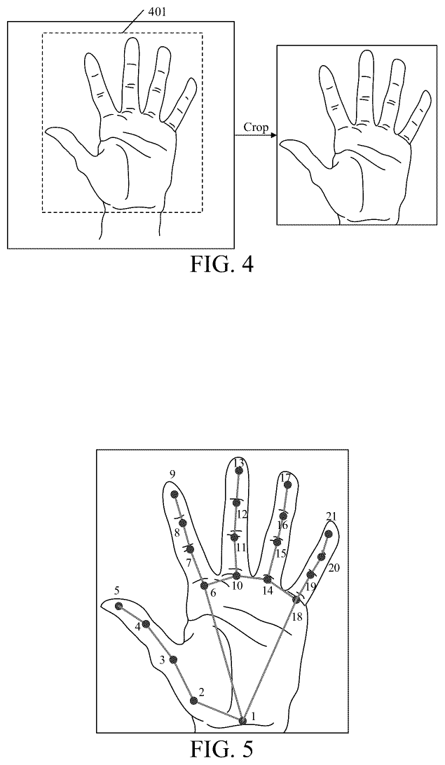

Some embodiments provide an image processing method. The image processing method mainly describes a process of performing depth-of-field analysis on a photographed image of a biological object. The image processing method may be performed by an electronic device. The electronic device may be an image processing device in an image processing system. As shown in FIG. 3, the image processing method may include the following operation S301 to operation S304.

S301: Photograph a to-be-detected biological object in a living-body detection scenario and a background of the biological object to obtain a photographed image.

The photographing a to-be-detected biological object in a living-body detection scenario and a background of the biological object may be photographing the biological object and the background of the biological object by using a photographing device. In addition, during the photographing of the biological object by the photographing device, the biological object may perform a corresponding action. For example, when the biological object is a hand, a corresponding gesture may be made. For another example, when the biological object is a human face, actions such as blinking, opening the mouth, shaking the head, and nodding may be made.

S302: Perform depth-of-field analysis on the photographed image, to obtain depth-of-field information of the biological object and depth-of-field information of the background.

After the photographed image of the to-be-detected biological object in the living-body detection scenario is obtained, depth-of-field analysis may be performed on the photographed image. Depth-of-field analysis refers to a process of analyzing the photographed image to obtain depth-of-field information of the biological object and depth-of-field information of the background. The depth-of-field information of the biological object may be configured for indicating a distance between the biological object and the photographing device. The depth-of-field information of the background may be configured for indicating a distance between the background and the photographing device. For a process of depth-of-field analysis, refer to the following content:

First, a biological region image corresponding to the biological object and a background region image corresponding to a background may be determined in the photographed image. Then, image blurriness of the biological region image may be determined, and the image blurriness of the biological region image is determined as the depth-of-field information of the biological object. In addition, image blurriness of the background region image is determined, and the image blurriness of the background region image is determined as the depth-of-field information of the background. For the foregoing process of depth-of-field analysis, the following three points are described:

First: The biological region image corresponding to the biological object refers to an image region including the biological object in the photographed image. Image content of the biological region image may be entirely the biological object, or a proportion of the biological object in the image content of the biological region image is much higher than that of the background. The background region image corresponding to the background refers to an image region including the background in the photographed image. Image content of the background region image may be entirely the background, or a proportion of the background in the image content of the background region image is much higher than that of the biological object. In other words, the biological region image and the background region image may be separately extracted, a depth of field of the biological object is calculated based on the biological region image, and a depth of field of the background is calculated based on the background region image. This can improve calculation accuracy of the depth of field of the biological object and the depth of field of the background, and accuracy of the depth-of-field analysis.

Second: During the photographing of the biological object by the photographing device, the distance between the biological object and the photographing device is relatively short and the distance between the background and the photographing device is relatively long, the depth-of-field information of the biological object is different from the depth-of-field information of the background. As a result, in the photographed image, the image blurriness of the biological region image is different from the image blurriness of the background region image. The image blurriness refers to an image blurriness degree, and calculation costs of the image blurriness degree are relatively low. In some embodiments, the depth-of-field information is represented by using the image blurriness, the depth-of-field information of the biological object is represented by using the image blurriness of the biological region image, and the depth-of-field information of the background is represented by using the image blurriness of the background region image. This can improve calculation efficiency of the depth of field.

Third: To further improve efficiency of determining, in the photographed image, the biological region image corresponding to the biological object and the background region image corresponding to the background, after the photographed image is obtained, the photographed image may be pre-processed. A process of pre-processing may be determining a position region of the biological object in the photographed image by using a target detection algorithm involved in technologies such as ML and CV. As shown in FIG. 4, using an example in which the biological object is a hand, the position region of the biological object in the photographed image may be marked by using a biological object detection block 401. The photographed image may be cropped based on the position region of the biological object in the photographed image, and the biological region image corresponding to the biological object and the background region image corresponding to the background are determined in an image obtained through cropping. In this way, efficiency of determining, in the photographed image, the biological region image corresponding to the biological object and the background region image corresponding to the background can be improved. The process of determining, in the photographed image, the biological region image corresponding to the biological object and the background region image corresponding to the background is the same as the process of determining, in the cropped image, the biological region image corresponding to the biological object and the background region image corresponding to the background. Some embodiments mainly describes the process of determining, in the photographed image, the biological region image corresponding to the biological object and the background region image corresponding to the background.

The foregoing describes an overall procedure of the depth-of-field analysis, and the following describes a detailed procedure of each operation of the depth-of-field analysis. The process of determining, in the photographed image, a biological region image corresponding to the biological object and a background region image corresponding to the background may include: performing skeleton analysis on the biological object in the photographed image to obtain skeleton information of the biological object. The skeleton information of the biological object may include position information of at least one skeleton point of the biological object in the photographed image. The skeleton analysis may be implemented by using a regressor involved in technologies such as ML and CV. As shown in FIG. 5, using an example in which the biological object is a hand, the regressor performs skeleton analysis on the biological object to obtain 21 skeleton points. The biological region image may be determined in the photographed image according to the skeleton information of the biological object. The background region image may be determined in the photographed image according to the skeleton information of the biological object.

Using an example in which the biological object is a hand, a manner of determining the biological region image in the photographed image according to the skeleton information of the biological object may include any one of the following:

(1) Determine, when the skeleton information of the biological object includes position information of finger skeleton points in the photographed image, a finger region image in the photographed image according to the position information of the finger skeleton points in the photographed image, and determine the finger region image as the biological region image.

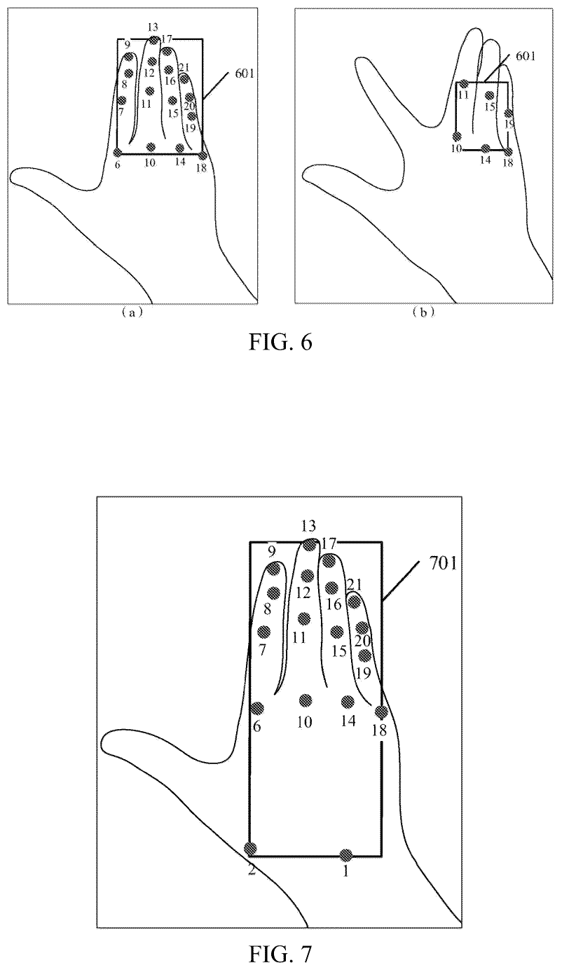

As shown in a sub-figure (a) in FIG. 6, to prevent a background exposed between fingers from affecting depth-of-field calculation, the living-body detection may involve a user making a gesture of bringing fingers together, and skeleton points numbered 6 to 21 may be selected as finger skeleton points. A finger envelope box 601 may be calculated according to position information of the finger skeleton points in the photographed image, and a region enveloped by the finger envelope box 601 is a finger region image. For a manner of calculating the finger envelope box, refer to the following formula (1):

$$\{ \begin{matrix}( {x}_{min} , {y}_{min} ) = min ( {x}_{k} , {y}_{k} ) \\ ( {x}_{max} , {y}_{max} ) = max ( {x}_{k} , {y}_{k} )\end{matrix} , 0 \leq k < K . \qquad formula ( 1 )$$

As shown in the foregoing formula (1): K represents a total quantity of the finger skeleton points, k represents a k^{th} finger skeleton point in the K finger skeleton points, and position information of the k^{th} finger skeleton point in the photographed image may be represented by using coordinate information (xₖ, yₖ) of the k^{th} finger skeleton point in the photographed image. min(xₖ, yₖ) represents a minimum horizontal coordinate xₘᵢₙ and a minimum vertical coordinate yₘᵢₙ selected from coordinate information of the K finger skeleton points; max(xₖ>yₖ) represents a maximum horizontal coordinate xₘₐₓ and a maximum vertical coordinate yₘₐₓ selected from the coordinate information of the K finger skeleton points; and the finger envelope box may be obtained according to the minimum horizontal coordinate xₘᵢₙ, the minimum vertical coordinate yₘᵢₙ, the maximum horizontal coordinate xₘₐₓ, and the maximum vertical coordinate yₘₐₓ together, the minimum horizontal coordinate xₘᵢₙ may be configured for determining a left boundary of the finger envelope box, the minimum vertical coordinate yₘᵢₙ may be configured for determining an upper boundary of the finger envelope box, the maximum horizontal coordinate xₘₐₓ may be configured for determining a right boundary of the finger envelope box, and a maximum vertical coordinate yₘₐₓ may be configured for determining a lower boundary of the finger envelope box. In some embodiments, a coordinate system is established by using a horizontal to right direction as a forward direction of a horizontal coordinate, and using a vertical to down direction as a forward direction of a vertical coordinate.

A manner of determining a biological region image shown in sub-figure (a) in FIG. 6 may be construed as using a full-finger region image of four fingers except the thumb as the biological region image. The biological region image determined in this manner has a flaw. Due to different lengths of the fingers, the biological region image obtained through determining in the manner shown in sub-figure (a) in FIG. 6 may include part of the background. This affects calculation accuracy of image blurriness of the biological region image, and thus affects accuracy of depth-of-field information of the biological object. A partial finger region image may be used as the biological region image. As shown in sub-figure (b) in FIG. 6, skeleton points numbered {10, 11, 14, 15, 18, 19} may be selected as finger skeleton points. A finger envelope box 601 may be calculated according to position information of the finger skeleton points in the photographed image. A region enveloped by the finger envelope box 601 is the finger region image. A manner of calculating the finger envelope box in sub-figure (b) in FIG. 6 is consistent with the manner of calculating the finger envelope box in sub-figure (a) in FIG. 6. For reference, refer to the manner of calculating the finger envelope box in sub-figure (a) in FIG. 6.

(2) Determine, when the skeleton information of the biological object includes position information of full-hand skeleton points in the photographed image, a full-hand region image in the photographed image according to the position information of the full-hand skeleton points in the photographed image, and determine the full-hand region image as the biological region image.

As shown in FIG. 7, skeleton points other than skeleton points located at the thumb may be used as full-hand skeleton points. A full-hand envelope box 701 may be calculated according to position information of the full-hand skeleton points in the photographed image. A region enveloped by the full-hand envelope box 701 is a full-hand region image. A manner of calculating the full-hand envelope box is consistent with the manner of calculating the finger envelope box. For reference, refer to the foregoing manner of calculating the finger envelope box. An advantage of determining the full-hand region image as the biological region image is that more than 85% of image content in the biological region image is the biological object. This can greatly reduce impact of less than 15% of the background in the image content of the biological region image on calculation of depth-of-field information of the biological object.

(3) Determine, when the skeleton information of the biological object includes position information of palm skeleton points in the photographed image, a palm region image in the photographed image according to the position information of the palm skeleton points in the photographed image, and determine the palm region image as the biological region image.

As shown in FIG. 8, skeleton points numbered {1, 2, 6, 10, 14, 18} may be selected as palm skeleton points, a palm envelope box 801 may be calculated according to position information of the palm skeleton points in the photographed image, and a region enveloped by the palm envelope box 801 is a palm region image. A manner of calculating the palm envelope box is consistent with a manner of calculating the finger envelope box. For reference, refer to the foregoing manner of calculating the finger envelope box. Comparison is performed between the manner of determining the palm region image as the biological region image and the manner of determining the finger region image or the full-hand region image as the biological region image. The manner of determining the finger region image or the full-hand region image as the biological region image may involve a user making a corresponding gesture for the living-body detection. For any gesture, a palm region is relatively stable. The manner of determining the palm region image as the biological region image can improve convenience of the user for living-body detection, and the user can make any gesture without making a corresponding gesture. In addition, image content of the biological region image determined according to the palm region image is entirely the biological object, so that calculation accuracy of depth-of-field information of the biological object can be improved.

Using an example in which the biological object is a hand, a manner of determining the background region image in the photographed image according to the skeleton information of the biological object may include any one of the following:

(1) Determine, when the skeleton information of the biological object further includes position information of hand boundary skeleton points in the photographed image, a hand boundary region image in the photographed image according to the position information of the hand boundary skeleton points in the photographed image and image boundary position information of the photographed image, and determine the hand boundary region image as the background region image.

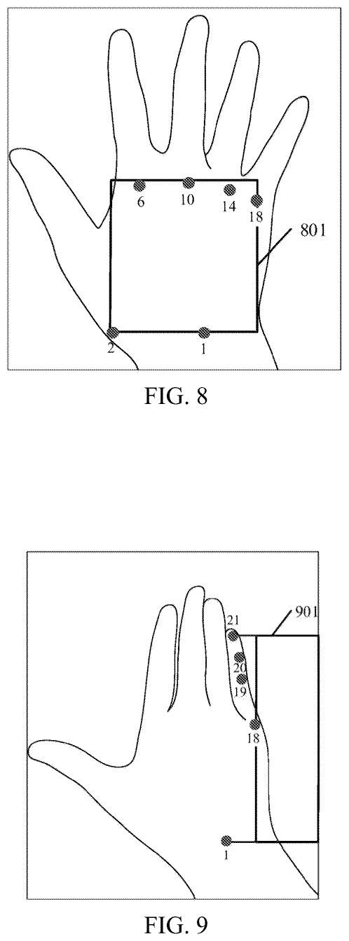

As shown in FIG. 9, skeleton points numbered {1, 18, 19, 20, 21} may be selected as hand boundary skeleton points, a hand boundary envelope box 901 may be calculated according to position information of the hand boundary skeleton points in the photographed image and image boundary position information, and a region enveloped by the hand boundary envelope box 901 is a hand boundary region image. A lower boundary of the hand boundary envelope box may be determined according to a vertical coordinate of the skeleton point numbered 1, a left boundary of the hand boundary envelope box may be determined according to a maximum horizontal coordinate of the skeleton points numbered {18, 19, 20, 21}, an upper boundary of the hand boundary envelope box may be determined according to a minimum vertical coordinate of the skeleton points numbered {18, 19, 20, 21}, and a right boundary of the hand boundary envelope box may be determined according to the image boundary position information of the photographed image. The background region image may be extracted at a gap between the little finger and an edge of the photographed image.

(2) Determine, when the skeleton information of the biological object further includes position information of purlicue skeleton points in the photographed image, a purlicue region image in the photographed image according to the position information of the purlicue skeleton points in the photographed image, and determine the purlicue region image as the background region image.

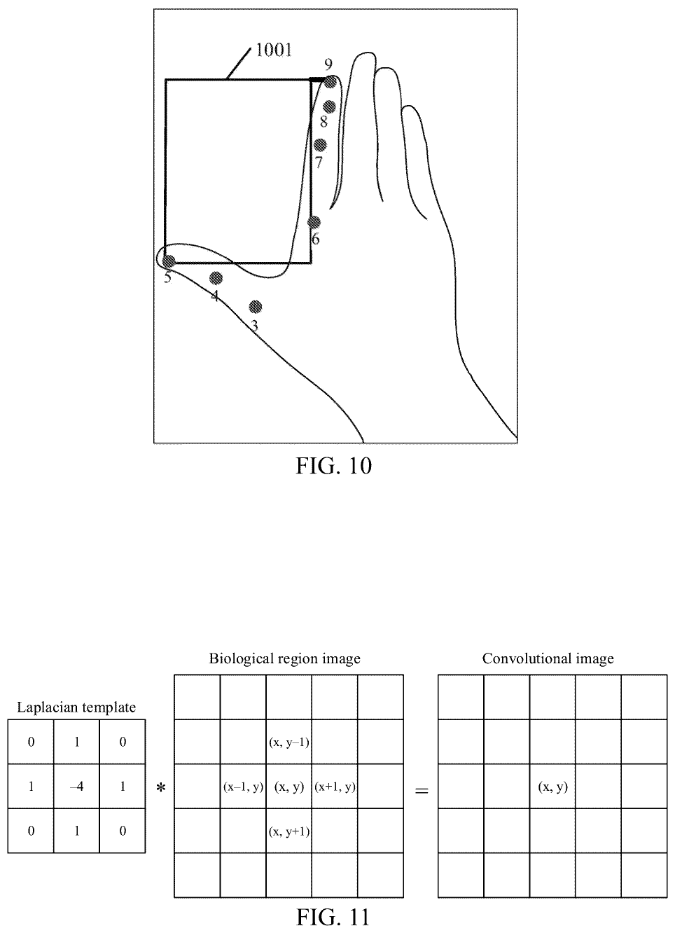

There may be a problem in the foregoing determining the hand boundary region image as the background region image. When the little finger is excessively close to the boundary of the photographed image, the determined background region image is empty. A manner of determining a purlicue region image as the background region image is provided. This manner may use slight cooperation of the user to ensure that the thumb is in an open state, so that the background region image can be obtained. As shown in FIG. 10, skeleton points numbered {3, 4, 5, 6, 7, 8, 9} may be selected as purlicue skeleton points, a purlicue envelope box 1001 may be calculated according to position information of the purlicue skeleton points in the photographed image, and a region enveloped by the purlicue envelope box 1001 is a purlicue region image. For a manner of calculating the purlicue envelope box, refer to the following descriptions: The purlicue skeleton points may include thumb skeleton points numbered {3, 4, 5} and index finger skeleton points numbered {6, 7, 8, 9}. A lower boundary of the purlicue envelope box may be determined according to a vertical coordinate of a highest skeleton point of the thumb skeleton points (a minimum vertical coordinate in the coordinate information of each thumb skeleton point). A left boundary of the purlicue envelope box may be determined according to a horizontal coordinate of a leftmost skeleton point of the thumb skeleton points (a minimum horizontal coordinate in the coordinate information of each thumb skeleton point). An upper boundary of the purlicue envelope box may be determined according to a vertical coordinate of a highest skeleton point of the index finger skeleton points (a minimum vertical coordinate in the coordinate information of each index finger skeleton point). A right boundary of the purlicue envelope box may be determined according to a horizontal coordinate of a leftmost skeleton point of the index finger skeleton points (a minimum horizontal coordinate in the coordinate information of each index finger skeleton point).

The foregoing content describes the manners of determining the biological region image and the background region image in the photographed image. The following describes a manner of calculating image blurriness of the biological region image and a manner of calculating image blurriness of the background region image. The manner of calculating the image blurriness of the biological region image is the same as the manner of calculating the image blurriness of the background region image. The manner of calculating the image blurriness of the biological region image is described herein. For the manner of calculating the image blurriness of the background region image, refer to the manner of calculating the image blurriness of the biological region image. The manner of calculating the image blurriness of the biological region image may include: A Laplacian template may be obtained. Convolution processing may be performed on the biological region image by using the Laplacian template to obtain a convolutional image of the biological region image. Then, statistical calculation may be performed on pixel values of all pixels in the convolutional image of the biological region image to obtain the image blurriness of the biological region image. The statistical calculation herein may refer to performing variance calculation on the pixel values of all the pixels in the convolutional image of the biological region image, or performing standard deviation calculation on the pixel values of all the pixels in the convolutional image of the biological region image. The disclosure is not limited thereto.

For the process of performing convolution processing on the biological region image by using the Laplacian template, refer to the following formula (2):

$${∇}^{2} f ( x , y ) = f ( x + 1 , y ) + f ( x - 1 , y ) + f ( x , y + 1 ) + f ( x , y - 1 ) - 4 f ( x , y ) . \qquad formula ( 2 )$$

As shown in the foregoing formula (2), f(x, y) represents a pixel value of a current pixel (x, y) in the biological region image, f(x+1, y) represents a pixel value of a right-side pixel (x+1, y) located on the right of the current pixel (x, y) in the biological region image, f(x−1, y) represents a pixel value of a left-side pixel (x−1, y) located on the left of the current pixel (x, y) in the biological region image, f(x, y+1) represents a pixel value of a lower-side pixel (x, y+1) located on the lower side of the current pixel (x, y) in the biological region image, f(x, y−1) represents a pixel value of an upper-side pixel (x, y−1) located on an upper side of the current pixel (x, y) in the biological region image, and ∇²f(x, y) represents a pixel value of the current pixel (x, y) in the convolutional image. As shown in FIG. 11, a pixel value of a current pixel in a convolutional image may be obtained through calculation according to a pixel value of the current pixel in a biological region image, a pixel value of a left-side pixel of the current pixel in the biological region image, a pixel value of a right-side pixel of the current pixel in the biological region image, a pixel value of an upper-side pixel of the current pixel in the biological region image, and a pixel value of a lower-side pixel of the current pixel in the biological region image, and may be obtained through weighted summation. The Laplacian template defines weighted weights of the pixels (the current pixel, the left-side pixel, the right-side pixel, the upper-side pixel, and the lower-side pixel). A pixel value of each pixel in the biological region image in the convolutional image may be calculated.

S303: Compare the depth-of-field information of the biological object with the depth-of-field information of the background, to obtain a comparison result.

S304: Determine a living-body detection result of the biological object according to the comparison result, the living-body detection result being configured for indicating whether the biological object in the living-body detection scenario is a real living object.

In operation S303 and operation S304, after the depth-of-field information of the biological object and the depth-of-field information of the background are obtained, the depth-of-field information of the biological object may be compared with the depth-of-field information of the background, to determine whether the biological object and the background are in a same plane, to determine whether the living-body detection scenario suffers a video playback attack. A living-body detection result of the biological object may be determined according to a comparison result.

In some embodiments, the biological region image corresponding to the biological object and the background region image corresponding to the background can be determined in the photographed image of the biological object. It can be ensured that all or most of the image content of the biological region image is the biological object, and the depth-of-field information of the biological object can be accurately represented by using the image blurriness of the biological region image. It can be ensured that all or most of the image content of the background region image is the background, and the depth-of-field information of the background can be accurately represented by using the image blurriness of the background region image. Therefore, through the comparison between the depth-of-field information of the biological object and the depth-of-field information of the background, the living-body detection result of the biological object can be accurately determined according to the comparison result, thereby improving accuracy of living-body detection.

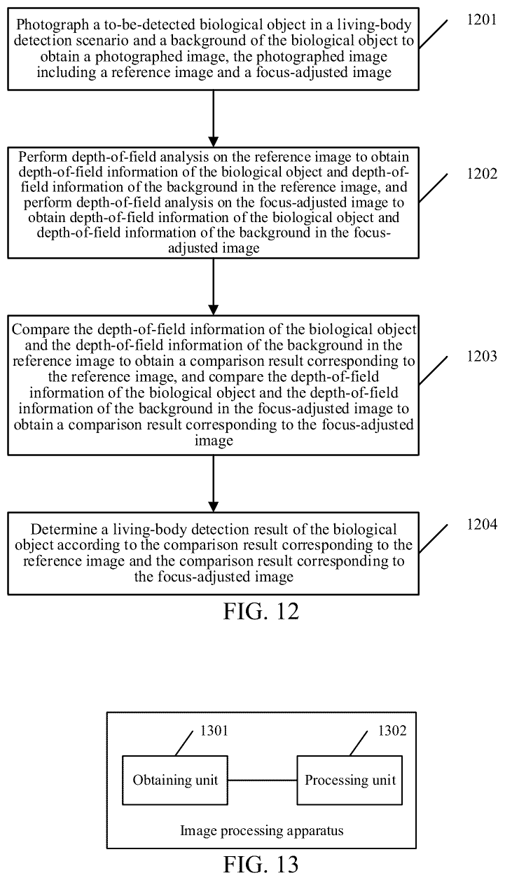

Some embodiments provide an image processing method. The image processing method mainly describes a manner of comparing depth-of-field information of a biological object with depth-of-field information of a background. The image processing method may be performed by an electronic device. The electronic device may be an image processing device in an image processing system. As shown in FIG. 12, the image processing method may include the following operation S1201 to operation S1204.

S1201: Photograph a to-be-detected biological object in a living-body detection scenario and a background of the biological object to obtain a photographed image, the photographed image including a reference image and a focus-adjusted image.

A to-be-detected biological object in a living-body detection scenario is photographed, and a photographed image obtained may include a reference image and a focus-adjusted image. The reference image may be obtained by a photographing device by photographing the biological object and the background of the biological object according to a reference focal length. The focus-adjusted image may be obtained by the photographing device by photographing the biological object and the background of the biological object after a focal length is adjusted.

S1202: Perform depth-of-field analysis on the reference image to obtain depth-of-field information of the biological object and depth-of-field information of the background in the reference image, and perform depth-of-field analysis on the focus-adjusted image to obtain depth-of-field information of the biological object and depth-of-field information of the background in the focus-adjusted image.

In operation S1202, for a process of performing depth-of-field analysis on the reference image, reference may be made to the process of performing depth-of-field analysis on the photographed image in operation S302 in some embodiments shown in FIG. 3. Performing depth-of-field analysis on the reference image can obtain depth-of-field information of the biological object and depth-of-field information of the background in the reference image. For a process of performing depth-of-field analysis on the focus-adjusted image, reference may be made to the process of performing depth-of-field analysis on the photographed image in operation S302 of some embodiments shown in FIG. 3. Performing depth-of-field analysis on the focus-adjusted image can obtain depth-of-field information of the biological object and depth-of-field information of the background in the focus-adjusted image.

S1203: Compare the depth-of-field information of the biological object and the depth-of-field information of the background in the reference image to obtain a comparison result corresponding to the reference image, and compare the depth-of-field information of the biological object and the depth-of-field information of the background in the focus-adjusted image to obtain a comparison result corresponding to the focus-adjusted image.

For the reference image, comparing the depth-of-field information of the biological object and the depth-of-field information of the background in the reference image can obtain a comparison result corresponding to the reference image. The comparison result corresponding to the reference image may indicate that in the reference image, the depth-of-field information of the biological object matches the depth-of-field information of the background, or that in the reference image, the depth-of-field information of the biological object does not match the depth-of-field information of the background. That in the reference image, the depth-of-field information of the biological object matches the depth-of-field information of the background may mean that in the reference image, the depth-of-field information of the biological object is the same as the depth-of-field information of the background, or that an absolute value of a difference between the depth-of-field information of the biological object and the depth-of-field information of the background in the reference image is less than an absolute value threshold. That in the reference image, the depth-of-field information of the biological object does not match the depth-of-field information of the background may mean that in the reference image, the depth-of-field information of the biological object is different from the depth-of-field information of the background, or that an absolute value of a difference between the depth-of-field information of the biological object and the depth-of-field information of the background in the reference image is greater than or equal to an absolute value threshold.

For the focus-adjusted image, comparing the depth-of-field information of the biological object and the depth-of-field information of the background in the focus-adjusted image can obtain a comparison result corresponding to the focus-adjusted image. The comparison result corresponding to the focus-adjusted image may indicate that in the focus-adjusted image, the depth-of-field information of the biological object matches the depth-of-field information of the background, or that in the focus-adjusted image, the depth-of-field information of the biological object does not match the depth-of-field information of the background. That in the focus-adjusted image, the depth-of-field information of the biological object matches the depth-of-field information of the background may mean that in the focus-adjusted image, the depth-of-field information of the biological object is the same as the depth-of-field information of the background, or that an absolute value of a difference between the depth-of-field information of the biological object and the depth-of-field information of the background in the focus-adjusted image is less than an absolute value threshold. That in the focus-adjusted image, the depth-of-field information of the biological object does not match the depth-of-field information of the background may mean that in the focus-adjusted image, the depth-of-field information of the biological object is different from the depth-of-field information of the background, or that an absolute value of a difference between the depth-of-field information of the biological object and the depth-of-field information of the background in the focus-adjusted image is greater than or equal to an absolute value threshold.

When the depth-of-field information of the biological object is the same as the depth-of-field information of the background, it is determined that the depth-of-field information of the biological object matches the depth-of-field information of the background. Such a matching determining manner can ensure that when the depth-of-field information of the biological object matches the depth-of-field information of the background, the depth-of-field information of the biological object is absolutely the same as the depth-of-field information of the background. When a difference between the depth-of-field information of the biological object and the depth-of-field information of the background is relatively small, it is determined that the depth-of-field information of the biological object matches the depth-of-field information of the background. Such a matching determining manner can ensure that when the depth-of-field information of the biological object matches the depth-of-field information of the background, the depth-of-field information of the biological object is relatively the same as the depth-of-field information of the background, allowing a particular degree of error tolerance. This can avoid a case of determining that a living-body detection process does not suffer a video playback attack when the depth-of-field information of the biological object is different from the depth-of-field information of the background due to a calculation error during the video playback attack.

S1204: Determine a living-body detection result of the biological object according to the comparison result corresponding to the reference image and the comparison result corresponding to the focus-adjusted image.

After the comparison result corresponding to the reference image and the comparison result corresponding to the focus-adjusted image are obtained, a living-body detection result of the biological object may be determined according to the comparison result corresponding to the reference image and the comparison result corresponding to the focus-adjusted image.

In some embodiments, a quantity of focus-adjusted images is N, N being an integer greater than 1. The N focus-adjusted images may be obtained by the photographing device by photographing the biological object and the background of the biological object after N adjustments of the focal length with the biological object or the background as a reference, and one focus-adjusted image is obtained through photographing with one adjustment of the focal length. That the photographing device performs an adjustment on the focal length with the biological object as a reference may be construed as the photographing device performing an adjustment on the focal length with changing image blurriness of a biological region image corresponding to the biological object as a target, without considering image blurriness of a background region image corresponding to the background. That the photographing device performs an adjustment on the focal length with the background as a reference may be construed as the photographing device performing an adjustment on the focal length with changing image blurriness of a background region image corresponding to the background as a target, without considering image blurriness of a biological region image corresponding to the biological object.

A process of determining the living-body detection result of the biological object according to the comparison result corresponding to the reference image and the comparison result corresponding to the focus-adjusted image may include the following: A target quantity of comparison results indicating that the depth-of-field information of the biological object matches the depth-of-field information of the background may be counted in the comparison result corresponding to the reference image and comparison results corresponding to the N focus-adjusted images. A living-body detection result indicating a living-body detection failure may be generated if the target quantity is greater than or equal to a quantity threshold. A living-body detection result indicating a living-body detection success may be generated if the target quantity is less than a quantity threshold.

In more detail, as an example, that the depth-of-field information of the biological object matches the depth-of-field information of the background means that the depth-of-field information of the biological object is the same as the depth-of-field information of the background, and that the depth-of-field information of the biological object does not match the depth-of-field information of the background means that the depth-of-field information of the biological object is different from the depth-of-field information of the background. This may be construed as setting a count value for the comparison result corresponding to the reference image and the comparison results corresponding to the N focus-adjusted images. If the depth-of-field information of the biological object is the same as the depth-of-field information of the background in a current comparison result, it may be considered that the depth-of-field information of the biological object matches the depth-of-field information of the background, and the count value may be updated. An update manner may be: count value=count value+1. If the depth-of-field information of the biological object is different from the depth-of-field information of the background in a current comparison result, it may be considered that the depth-of-field information of the biological object does not match the depth-of-field information of the background, and the count value may remain unchanged. Refer to the following formula (3):

$$if {Laplacian}_{front} == {Laplacian}_{b a c k} , N u {m}_{e q u a l} + = 1. \qquad formula ( 3 )$$

As shown in the foregoing formula (3): Laplacian_{front} represents the depth-of-field information of the biological object, and Laplacian_{back} represents depth-of-field information of the background. If the depth-of-field information of the biological object is the same as the depth-of-field information of the background, if Laplacian_{front}==Laplacian_{back}, a count value Num_{equal} may be updated. If the depth-of-field information of the biological object is different from the depth-of-field information of the background, if Laplacian_{front}≠Laplacian_{back}, a count value Num_{equal} may remain unchanged.

All comparison results in the comparison result corresponding to the reference image and the comparison results corresponding to the focus-adjusted images may be sequentially processed. After the last comparison result in the comparison result corresponding to the reference image and the comparison results corresponding to the N focus-adjusted images is processed, an obtained count value is the target quantity of comparison results indicating that the depth-of-field information of the biological object matches the depth-of-field information of the background in the comparison result corresponding to the reference image and the comparison results corresponding to the N focus-adjusted images. If the target quantity is greater than or equal to the quantity threshold, a living-body detection result indicating a living-body detection failure may be generated. If the target quantity is less than the quantity threshold, a living-body detection result indicating a living-body detection success may be generated. Refer to the following formula (4):

$$\{ \begin{matrix}if {Num}_{equal} \geq {Thres}_{equal} , living - body detection failure \\ if {Num}_{equal} < {Thres}_{equal} , living - body detection success\end{matrix} . \qquad formula ( 4 )$$

As shown in the foregoing formula (4): Num_{equal} represents a count value, a target quantity, obtained after the comparison result corresponding to the reference image and the comparison results corresponding to the N focus-adjusted images are processed; and Thres_{equal} represents the quantity threshold, and the quantity threshold may be a positive integer less than or equal to N.

It is clear that, in this implementation, whether the depth-of-field information of the biological object matches the depth-of-field information of the background in an image obtained through photographing after each adjustment of the focal length may be determined through comparison, and whether the biological object passes the living-body detection is comprehensively analyzed according to comparison results obtained after a plurality of adjustments of the focal length. Compared with a manner of determining, according to a comparison result of a single image, whether the biological object passes the living-body detection, the manner of a plurality of adjustments of the focal length can avoid a case of incorrectly determining the living-body detection result when an error occurs in the comparison result of the single image. The manner of a plurality of adjustments of the focal length enables the living-body detection result obtained through determining to be more reliable and more accurate.

In some embodiments, the focus-adjusted image may include N first focus-adjusted images and M second focus-adjusted images, N and M each being an integer greater than 1. The N first focus-adjusted images may be obtained by the photographing device by photographing the biological object and the background of the biological object after N first adjustments of the focal length with the biological object as a reference, and one first focus-adjusted image is obtained through photographing with one first adjustment of the focal length. That the photographing device performs a first adjustment on the focal length with the biological object as a reference may be construed as the photographing device performing an adjustment on the focal length with changing image blurriness of a biological region image corresponding to the biological object as a target, without considering image blurriness of a background region image corresponding to the background. The M second focus-adjusted images may be obtained by the photographing device by photographing the biological object and the background of the biological object after M second adjustments of the focal length with the background as a reference, and one second focus-adjusted image is obtained through photographing with one second adjustment of the focal length. That the photographing device performs a second adjustment on the focal length with the background as a reference may be construed as the photographing device performing an adjustment on the focal length with changing image blurriness of a background region image corresponding to the background as a target, without considering image blurriness of a biological region image corresponding to the biological object.

A process of determining the living-body detection result of the biological object according to the comparison result corresponding to the reference image and the comparison result corresponding to the focus-adjusted image may include the following: A quantity of comparison results that are in the comparison result corresponding to the reference image and comparison results corresponding to the N first focus-adjusted images and that indicate that the depth-of-field information of the biological object matches the depth-of-field information of the background may be determined as a first quantity. A quantity of comparison results that are in the comparison result corresponding to the reference image and comparison results corresponding to the M second focus-adjusted images and that indicate that the depth-of-field information of the biological object matches the depth-of-field information of the background may be determined as a second quantity. A comprehensive quantity may be calculated according to the first quantity and the second quantity. For example, the comprehensive quantity may be a result of performing weighted summation on the first quantity and the second quantity. A living-body detection result indicating a living-body detection failure may be generated if the comprehensive quantity is greater than or equal to a quantity threshold. A living-body detection result indicating a living-body detection success may be generated if the comprehensive quantity is less than a quantity threshold.

In this implementation, the plurality of adjustments of the focal length may be performed separately with the biological object as a reference and with the background as a reference. Whether depth-of-field information of the biological object matches depth-of-field information of the background in an image obtained through photographing after each adjustment of the focal length may be determined through comparison, and whether the biological object passes the living-body detection is comprehensively analyzed according to a comparison result obtained after an adjustment of the focal length with the biological object as a reference and a comparison result obtained after an adjustment of the focal length with the background as a reference. Compared with a manner of performing an adjustment on the focal length separately with the biological object or the background as a reference, this implementation has an increased dimension of focal length adjustment. This can further improve reliability and accuracy of the living-body detection result.

Contents of operation S1201 and operation S1202 describe a plurality of adjustments of the focal length performed on the photographing device, and whether depth-of-field information of the biological object matches depth-of-field information of the background is determined through comparison after each adjustment of the focal length, and whether the biological object passes the living-body detection is comprehensively analyzed according to comparison results obtained after the plurality of adjustments of the focal length. Compared with the comparison manner in which a plurality of adjustments of the focal length are performed, a simpler comparison manner may exist. A single photographed image obtained by the photographing device through a single time of photographing may be directly acquired, and depth-of-field analysis is performed on the photographed image to obtain depth-of-field information of the biological object and depth-of-field information of the background. The depth-of-field information of the biological object may be compared with the depth-of-field information of the background. If the depth-of-field information of the biological object matches the depth-of-field information of the background, a living-body detection result indicating a living-body detection failure is generated. If the depth-of-field information of the biological object does not match the depth-of-field information of the background, a living-body detection result indicating a living-body detection success is generated. Compared with the comparison manner in which a plurality of adjustments of the focal length are performed, the comparison manner of this manner is simpler, and efficiency of the living-body detection can be improved.

In some embodiments, whether the depth-of-field information of the biological object matches the depth-of-field information of the background in an image obtained through photographing after each adjustment of the focal length may be determined through comparison, and whether the biological object passes the living-body detection can be comprehensively analyzed according to comparison results obtained after a plurality of adjustments of the focal length. This, compared with a manner of determining, according to a comparison result of a single image, whether the biological object passes the living-body detection, achieves higher reliability and accuracy of the living-body detection result. The manner of determining, according to a comparison result of a single image, whether the biological object passes the living-body detection is simpler, and efficiency of the living-body detection is higher.

The methods of some embodiments are described in detail above. To better implement the foregoing solutions of some embodiments, correspondingly, an apparatus of some embodiments is provided below.

Referring to FIG. 13, FIG. 13 is a schematic structural diagram of an image processing apparatus according to some embodiments. The image processing apparatus may be disposed in an electronic device according to some embodiments. The electronic device may be the image processing device in some embodiments shown in FIG. 2A. The image processing apparatus shown in FIG. 13 may be a computer program (including program code) running in the electronic device, and the image processing apparatus may be configured to perform some or all operations in the method according to some embodiments shown in FIG. 3 or FIG. 12. Referring to FIG. 13, the image processing apparatus may include the following units:
an obtaining unit 1301, configured to photograph a to-be-detected biological object in a living-body detection scenario and a background of the biological object to obtain a photographed image; and
a processing unit 1302, configured to perform depth-of-field analysis on the photographed image, to obtain depth-of-field information of the biological object and depth-of-field information of the background.

The processing unit 1302 is further configured to compare the depth-of-field information of the biological object with the depth-of-field information of the background, to obtain a comparison result.

The processing unit 1302 is further configured to determine a living-body detection result of the biological object according to the comparison result, the living-body detection result being configured for indicating whether the biological object in the living-body detection scenario is a real living object.

In some embodiments, the processing unit 1302 is further configured to determine, in the photographed image, a biological region image corresponding to the biological object and a background region image corresponding to the background;
determine image blurriness of the biological region image, and determine the image blurriness of the biological region image as the depth-of-field information of the biological object; and
determine image blurriness of the background region image, and determine the image blurriness of the background region image as the depth-of-field information of the background.

In some embodiments, the processing unit 1302 is further configured to perform skeleton analysis on the biological object in the photographed image to obtain skeleton information of the biological object;
determine the biological region image in the photographed image according to the skeleton information of the biological object; and
determine the background region image in the photographed image according to the skeleton information of the biological object.

In some embodiments, the biological object is a hand; and the processing unit 1302 is further configured to: determine, when the skeleton information of the biological object includes position information of finger skeleton points in the photographed image, a finger region image in the photographed image according to the position information of the finger skeleton points in the photographed image, and determine the finger region image as the biological region image; or
determine, when the skeleton information of the biological object includes position information of full-hand skeleton points in the photographed image, a full-hand region image in the photographed image according to the position information of the full-hand skeleton points in the photographed image, and determine the full-hand region image as the biological region image; or
determine, when the skeleton information of the biological object includes position information of palm skeleton points in the photographed image, a palm region image in the photographed image according to the position information of the palm skeleton points in the photographed image, and determine the palm region image as the biological region image.

In some embodiments, the processing unit 1302 is further configured to: determine, when the skeleton information of the biological object further includes position information of purlicue skeleton points in the photographed image, a purlicue region image in the photographed image according to the position information of the purlicue skeleton points in the photographed image, and determine the purlicue region image as the background region image; or
determine, when the skeleton information of the biological object further includes position information of hand boundary skeleton points in the photographed image, a hand boundary region image in the photographed image according to the position information of the hand boundary skeleton points in the photographed image and image boundary position information of the photographed image, and determine the hand boundary region image as the background region image.

In some embodiments, the processing unit 1302 is further configured to obtain a Laplacian template; perform convolution processing on the biological region image by using the Laplacian template to obtain a convolutional image of the biological region image; and perform statistical calculation on pixel values of all pixels in the convolutional image of the biological region image to obtain the image blurriness of the biological region image.

In some embodiments, the photographed image includes a reference image and a focus-adjusted image, the reference image being obtained by a photographing device by photographing the biological object and the background of the biological object according to a reference focal length, and the focus-adjusted image being obtained by the photographing device by photographing the biological object and the background of the biological object after a focal length is adjusted;
the comparison result includes a comparison result corresponding to the reference image and a comparison result corresponding to the focus-adjusted image; the comparison result corresponding to the reference image is obtained by comparing depth-of-field information of the biological object and depth-of-field information of the background in a depth-of-field analysis result of the reference image; and the comparison result corresponding to the focus-adjusted image is obtained by comparing depth-of-field information of the biological object and depth-of-field information of the background in a depth-of-field analysis result of the focus-adjusted image; and
the processing unit 1302 is further configured to determine the living-body detection result of the biological object according to the comparison result corresponding to the reference image and the comparison result corresponding to the focus-adjusted image.

In some embodiments, a quantity of focus-adjusted images is N, N being an integer greater than 1; and the N focus-adjusted images are obtained by the photographing device by photographing the biological object and the background of the biological object after N adjustments of the focal length with the biological object or the background as a reference, and one focus-adjusted image is obtained through photographing with one adjustment of the focal length; and
the processing unit 1302 is further configured to count a target quantity of comparison results indicating that the depth-of-field information of the biological object matches the depth-of-field information of the background in the comparison result corresponding to the reference image and comparison results corresponding to the N focus-adjusted images; and
generate a living-body detection result indicating a living-body detection failure if the target quantity is greater than or equal to a quantity threshold; or generate a living-body detection result indicating a living-body detection success if the target quantity is less than a quantity threshold.

In some embodiments, the focus-adjusted image includes N first focus-adjusted images and M second focus-adjusted images, N and M each being an integer greater than 1; the N first focus-adjusted images are obtained by the photographing device by photographing the biological object and the background of the biological object after N first adjustments of the focal length with the biological object as a reference, and one first focus-adjusted image is obtained through photographing with one first adjustment of the focal length; and the M second focus-adjusted images are obtained by the photographing device by photographing the biological object and the background of the biological object after M second adjustments of the focal length with the background as a reference, and one second focus-adjusted image is obtained through photographing with one second adjustment of the focal length; and
the processing unit 1302 is further configured to: determine, as a first quantity, a quantity of comparison results that are in the comparison result corresponding to the reference image and comparison results corresponding to the N first focus-adjusted images and that indicate that the depth-of-field information of the biological object matches the depth-of-field information of the background;
determine, as a second quantity, a quantity of comparison results that are in the comparison result corresponding to the reference image and comparison results corresponding to the M second focus-adjusted images and that indicate that the depth-of-field information of the biological object matches the depth-of-field information of the background; and
calculate a comprehensive quantity according to the first quantity and the second quantity; and generate a living-body detection result indicating a living-body detection failure if the comprehensive quantity is greater than or equal to a quantity threshold; or generate a living-body detection result indicating a living-body detection success if the comprehensive quantity is less than a quantity threshold.

In some embodiments, the processing unit 1302 is further configured to: store the photographed image into a biological registry if the living-body detection result of the biological object indicates the living-body detection success; or
extract a biometric feature of the biological object in the photographed image and store the biometric feature into a biological registry, if the living-body detection result of the biological object indicates the living-body detection success.

In some embodiments, the processing unit 1302 is further configured to: perform matching detection on the photographed image with registered images in the biological registry if the living-body detection result of the biological object indicates the living-body detection success, and determine that authentication on the biological object succeeds when a registered image of the biological object that matches the photographed image is successfully detected; or
perform matching detection on the biometric feature of the biological object in the photographed image with registered biometric features in the biological registry if the living-body detection result of the biological object indicates the living-body detection success, and determine that authentication on the biological object succeeds when a registered biometric feature of the biological object that matches the biometric feature in the photographed image is successfully detected.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

According to some embodiments, the image processing apparatus shown in FIG. 13 may be constructed by and the image processing method in some embodiments may be implemented by running a computer program (including program code) capable of performing the operations in some or all of the methods shown in FIG. 3 or FIG. 12 on a computing device such as a computer including processing elements and memory elements such as a central processing unit (CPU), a random access memory (RAM), and a read-only memory (ROM). The computer program may be recorded in, for example, a computer-readable storage medium, and may be loaded into the foregoing computing device through the computer-readable storage medium and run in the computing device.

In some embodiments, a to-be-detected biological object in a living-body detection scenario and a background of the biological object may be photographed, to obtain a photographed image. Depth-of-field information of the biological object and depth-of-field information of the background can be obtained by performing depth-of-field analysis on the photographed image. Whether the depth-of-field information of the biological object matches the depth-of-field information of the background can be determined by comparing the depth-of-field information of the biological object with the depth-of-field information of the background. In a video playback attack, the depth-of-field information of the biological object matches the depth-of-field information of the background. The depth-of-field information of the biological object is compared with the depth-of-field information of the background, and a living-body detection result of the biological object is determined according to a comparison result, so that the video playback attack during living-body detection can be effectively resisted, thereby improving accuracy of the living-body detection.

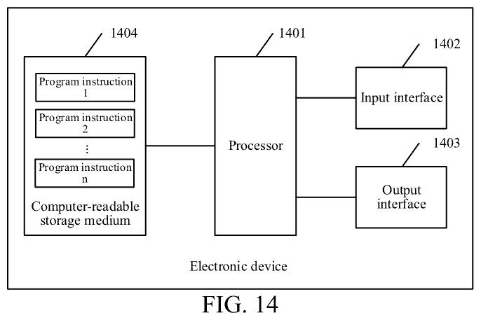

Based on the foregoing method and apparatus embodiments, some embodiments provide an electronic device. The electronic device may be an image processing device in the image processing system shown in FIG. 2A. Referring to FIG. 14, FIG. 14 is a schematic structural diagram of an electronic device according to some embodiments. The electronic device shown in FIG. 14 includes at least a processor 1401, an input interface 1402, an output interface 1403, and a computer-readable storage medium 1404. The processor 1401, the input interface 1402, the output interface 1403, and the computer-readable storage medium 1404 may be connected by using a bus or in another manner.

The computer-readable storage medium 1404 may be stored in a memory of the electronic device. The computer-readable storage medium 1404 is configured to store a computer program. The computer program includes computer instructions. The processor 1401 is configured to execute the program instructions stored in the computer-readable storage medium 1404. The processor 1401 (or referred to as a CPU) is a computing core and a control core of the electronic device, is for implementing one or more computer instructions, and is for loading and executing one or more computer instructions to implement a corresponding method procedure or a corresponding function.

Some embodiments provide a computer-readable storage medium (memory). The computer-readable storage medium is a storage device in an electronic device and is configured to store a program and data. The computer-readable storage medium herein may include both an internal storage medium in the electronic device and certainly an expanded storage medium supported by the electronic device. The computer-readable storage medium provides a storage space, storing an operating system of the electronic device. The storage space further stores one or more computer instructions for being loaded and executed by the processor. The computer instructions may be one or more computer programs (including program code). The computer-readable storage medium herein may be a high-speed RAM, or a non-volatile memory, for example, at least one magnetic disk memory; and in some embodiments, may be at least one computer-readable storage medium that is far away from the foregoing processor.

In some embodiments, the processor 1401 may load and execute one or more computer instructions stored in the computer-readable storage medium 1404, to implement corresponding operations of the image processing method shown in FIG. 3 or FIG. 12. During some embodiments, the computer instructions in the computer-readable storage medium 1404 are loaded by the processor 1401 to perform the following operations:
photographing a to-be-detected biological object in a living-body detection scenario and a background of the biological object to obtain a photographed image;
performing depth-of-field analysis on the photographed image, to obtain depth-of-field information of the biological object and depth-of-field information of the background;
comparing the depth-of-field information of the biological object with the depth-of-field information of the background, to obtain a comparison result; and
determining a living-body detection result of the biological object according to the comparison result, the living-body detection result being configured for indicating whether the biological object in the living-body detection scenario is a real living object.

In some embodiments, when the computer instructions in the computer-readable storage medium 1404 are loaded by the processor 1401 to perform depth-of-field analysis on the photographed image, to obtain the depth-of-field information of the biological object and the depth-of-field information of the background, the computer instructions are further configured to perform the following operations:
determining, in the photographed image, a biological region image corresponding to the biological object and a background region image corresponding to the background;
determining image blurriness of the biological region image, and determining the image blurriness of the biological region image as the depth-of-field information of the biological object; and
determining image blurriness of the background region image, and determining the image blurriness of the background region image as the depth-of-field information of the background.

In some embodiments, when the computer instructions in the computer-readable storage medium 1404 are loaded by the processor 1401 to perform determining, in the photographed image, the biological region image corresponding to the biological object and the background region image corresponding to the background, the computer instructions are further configured to perform the following operations:
performing skeleton analysis on the biological object in the photographed image to obtain skeleton information of the biological object;
determining the biological region image in the photographed image according to the skeleton information of the biological object; and
determining the background region image in the photographed image according to the skeleton information of the biological object.

In some embodiments, the biological object is a hand; and when the computer instructions in the computer-readable storage medium 1404 are loaded by the processor 1401 to perform determining the biological region image in the photographed image according to the skeleton information of the biological object, the computer instructions are further configured to perform the following operations:
determining, when the skeleton information of the biological object includes position information of finger skeleton points in the photographed image, a finger region image in the photographed image according to the position information of the finger skeleton points in the photographed image, and determining the finger region image as the biological region image; or
determining, when the skeleton information of the biological object includes position information of full-hand skeleton points in the photographed image, a full-hand region image in the photographed image according to the position information of the full-hand skeleton points in the photographed image, and determining the full-hand region image as the biological region image; or
determining, when the skeleton information of the biological object includes position information of palm skeleton points in the photographed image, a palm region image in the photographed image according to the position information of the palm skeleton points in the photographed image, and determining the palm region image as the biological region image.

In some embodiments, when the computer instructions in the computer-readable storage medium 1404 are loaded by the processor 1401 to perform determining the background region image in the photographed image according to the skeleton information of the biological object, the computer instructions are further configured to perform the following operations:
determining, when the skeleton information of the biological object further includes position information of purlicue skeleton points in the photographed image, a purlicue region image in the photographed image according to the position information of the purlicue skeleton points in the photographed image, and determining the purlicue region image as the background region image; or
determining, when the skeleton information of the biological object further includes position information of hand boundary skeleton points in the photographed image, a hand boundary region image in the photographed image according to the position information of the hand boundary skeleton points in the photographed image and image boundary position information of the photographed image, and determining the hand boundary region image as the background region image.

In some embodiments, when the computer instructions in the computer-readable storage medium 1404 are loaded by the processor 1401 to perform determining the image blurriness of the biological region image, the computer instructions are further configured to perform the following operations:
obtaining a Laplacian template;
performing convolution processing on the biological region image by using the Laplacian template to obtain a convolutional image of the biological region image; and
performing statistical calculation on pixel values of all pixels in the convolutional image of the biological region image to obtain the image blurriness of the biological region image.

In some embodiments, the photographed image includes a reference image and a focus-adjusted image, the reference image being obtained by a photographing device by photographing the biological object and the background of the biological object according to a reference focal length, and the focus-adjusted image being obtained by the photographing device by photographing the biological object and the background of the biological object after a focal length is adjusted;
the comparison result includes a comparison result corresponding to the reference image and a comparison result corresponding to the focus-adjusted image; the comparison result corresponding to the reference image is obtained by comparing depth-of-field information of the biological object and depth-of-field information of the background in a depth-of-field analysis result of the reference image; and the comparison result corresponding to the focus-adjusted image is obtained by comparing depth-of-field information of the biological object and depth-of-field information of the background in a depth-of-field analysis result of the focus-adjusted image; and
when the computer instructions in the computer-readable storage medium 1404 are loaded by the processor 1401 to perform determining the living-body detection result of the biological object according to the comparison result, the computer instructions are further configured to perform the following operations:
determining the living-body detection result of the biological object according to the comparison result corresponding to the reference image and the comparison result corresponding to the focus-adjusted image.

In some embodiments, a quantity of focus-adjusted images is N, N being an integer greater than 1; and the N focus-adjusted images are obtained by the photographing device by photographing the biological object and the background of the biological object after N adjustments of the focal length with the biological object or the background as a reference, and one focus-adjusted image is obtained through photographing with one adjustment of the focal length; and
when the computer instructions in the computer-readable storage medium 1404 are loaded by the processor 1401 to perform determining the living-body detection result of the biological object according to the comparison result corresponding to the reference image and the comparison result corresponding to the focus-adjusted image, the computer instructions are further configured to perform the following operations:
counting a target quantity of comparison results indicating that the depth-of-field information of the biological object matches the depth-of-field information of the background in the comparison result corresponding to the reference image and comparison results corresponding to the N focus-adjusted images; and
generating a living-body detection result indicating a living-body detection failure if the target quantity is greater than or equal to a quantity threshold; or generating a living-body detection result indicating a living-body detection success if the target quantity is less than a quantity threshold.

In some embodiments, the focus-adjusted image includes N first focus-adjusted images and M second focus-adjusted images, N and M each being an integer greater than 1; the N first focus-adjusted images are obtained by the photographing device by photographing the biological object and the background of the biological object after N first adjustments of the focal length with the biological object as a reference, and one first focus-adjusted image is obtained through photographing with one first adjustment of the focal length; and the M second focus-adjusted images are obtained by the photographing device by photographing the biological object and the background of the biological object after M second adjustments of the focal length with the background as a reference, and one second focus-adjusted image is obtained through photographing with one second adjustment of the focal length; and
when the computer instructions in the computer-readable storage medium 1404 are loaded by the processor 1401 to perform determining the living-body detection result of the biological object according to the comparison result corresponding to the reference image and the comparison result corresponding to the focus-adjusted image, the computer instructions are further configured to perform the following operations:
determining, as a first quantity, a quantity of comparison results that are in the comparison result corresponding to the reference image and comparison results corresponding to the N first focus-adjusted images and that indicate that the depth-of-field information of the biological object matches the depth-of-field information of the background;
determining, as a second quantity, a quantity of comparison results that are in the comparison result corresponding to the reference image and comparison results corresponding to the M second focus-adjusted images and that indicate that the depth-of-field information of the biological object matches the depth-of-field information of the background;
calculating a comprehensive quantity according to the first quantity and the second quantity; and generating a living-body detection result indicating a living-body detection failure if the comprehensive quantity is greater than or equal to a quantity threshold; or generating a living-body detection result indicating a living-body detection success if the comprehensive quantity is less than a quantity threshold.

In some embodiments, the computer instructions in the computer-readable storage medium 1404 are loaded by the processor 1401 and are further configured to perform the following operations:
storing the photographed image into a biological registry if the living-body detection result of the biological object indicates the living-body detection success; or
extracting a biometric feature of the biological object in the photographed image and storing the biometric feature into a biological registry, if the living-body detection result of the biological object indicates the living-body detection success.

In some embodiments, the computer instructions in the computer-readable storage medium 1404 are loaded by the processor 1401 and are further configured to perform the following operations:
performing matching detection on the photographed image with registered images in the biological registry if the living-body detection result of the biological object indicates the living-body detection success, and determining that authentication on the biological object succeeds when a registered image of the biological object that matches the photographed image is successfully detected; or
performing matching detection on the biometric feature of the biological object in the photographed image with registered biometric features in the biological registry if the living-body detection result of the biological object indicates the living-body detection success, and determining that authentication on the biological object succeeds when a registered biometric feature of the biological object that matches the biometric feature in the photographed image is successfully detected.

In some embodiments, a to-be-detected biological object in a living-body detection scenario and a background of the biological object may be photographed, to obtain a photographed image. Depth-of-field information of the biological object and depth-of-field information of the background can be obtained by performing depth-of-field analysis on the photographed image. Whether the depth-of-field information of the biological object matches the depth-of-field information of the background can be determined by comparing the depth-of-field information of the biological object with the depth-of-field information of the background. In a video playback attack, the depth-of-field information of the biological object matches the depth-of-field information of the background. The depth-of-field information of the biological object is compared with the depth-of-field information of the background, and a living-body detection result of the biological object is determined according to a comparison result, so that the video playback attack during living-body detection can be effectively resisted, thereby improving accuracy of the living-body detection.

According to one aspect of this application, a computer program product or a computer program is provided, the computer program product or the computer program including computer instructions, and the computer instructions being stored in a computer-readable storage medium. A processor of an electronic device reads the computer instructions from the computer-readable storage medium, and the processor executes the computer instructions to cause the electronic device to perform the image processing methods provided in the various optional implementations described above.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, performed by an electronic device, and comprising:
obtaining a photographed image by photographing a biological object to be detected in a living-body detection scenario, and a background of the biological object;
performing depth-of-field analysis on the photographed image, to obtain first depth-of-field information of the biological object and second depth-of-field information of the background;
comparing the first depth-of-field information with the second depth-of-field information, to obtain a comparison result;
determining, based on the comparison result, a living-body detection result indicating whether the biological object in the living-body detection scenario is a real living object; and
performing at least one of:
storing the photographed image into a biological registry if the living-body detection result of the biological object indicates a living-body detection success; or
extracting a biometric feature of the biological object in the photographed image and storing the biometric feature into the biological registry, if the living-body detection result of the biological object indicates the living-body detection success.

2. The image processing method according to claim 1, wherein the performing the depth-of-field analysis comprises:
determining, in the photographed image, a biological region image corresponding to the biological object and a background region image corresponding to the background;
determining image blurriness of the biological region image, and determining the image blurriness of the biological region image as the first depth-of-field information; and
determining image blurriness of the background region image, and determining the image blurriness of the background region image as the second depth-of-field information.

3. The image processing method according to claim 2, wherein the determining the biological region image comprises:
performing skeleton analysis on the biological object in the photographed image to obtain skeleton information of the biological object;
determining the biological region image in the photographed image according to the skeleton information of the biological object; and
determining the background region image in the photographed image according to the skeleton information of the biological object.

4. The image processing method according to claim 3, wherein the biological object is a hand, and
wherein the determining the biological region image comprises at least one of:
determining, based on the skeleton information of the biological object comprising first position information of finger skeleton points in the photographed image, a finger region image in the photographed image according to the first position information, and determining the finger region image as the biological region image;
determining, based on the skeleton information of the biological object comprising second position information of full-hand skeleton points in the photographed image, a full-hand region image in the photographed image according to the second position information, and determining the full-hand region image as the biological region image; or
determining, based on the skeleton information of the biological object comprising third position information of palm skeleton points in the photographed image, a palm region image in the photographed image according to the third position information, and determining the palm region image as the biological region image.

5. The image processing method according to claim 4, wherein the determining the background region image comprises at least one of:
determining, based on the skeleton information of the biological object further comprising fourth position information of purlicue skeleton points in the photographed image, a purlicue region image in the photographed image according to the fourth position information, and determining the purlicue region image as the background region image; or
determining, based on the skeleton information of the biological object further comprising fifth position information of a plurality of hand boundary skeleton points in the photographed image, a hand boundary region image in the photographed image according to the fifth position information and sixth position information of an image boundary of the photographed image, and determining the hand boundary region image as the background region image.

6. The image processing method according to claim 2, wherein the determining image blurriness of the biological region image comprises:
obtaining a Laplacian template;
performing convolution processing on the biological region image by using the Laplacian template to obtain a convolutional image of the biological region image; and
performing statistical calculation on pixel values of a plurality of pixels in the convolutional image of the biological region image to obtain the image blurriness of the biological region image.

7. The image processing method according to claim 1, wherein the photographed image comprises a reference image and a focus-adjusted image, the reference image being obtained by photographing the biological object and the background of the biological object according to a reference focal length, and the focus-adjusted image being obtained by photographing the biological object and the background of the biological object after a focal length is adjusted,
wherein the comparison result comprises a first comparison result corresponding to the reference image and a second comparison result corresponding to the focus-adjusted image; and the first comparison result is obtained by comparing the first depth-of-field information and the second depth-of-field information in a first depth-of-field analysis result of the reference image,
wherein the second comparison result is obtained by comparing the first depth-of-field information and the second depth-of-field information in a second depth-of-field analysis result of the focus-adjusted image, and
wherein the determining the living-body detection result comprises:
determining the living-body detection result of the biological object according to the first comparison result and the second comparison result.

8. The image processing method according to claim 7, wherein a quantity of focus-adjusted images is N, N being an integer greater than 1; and N focus-adjusted images are obtained by photographing the biological object and the background of the biological object after N adjustments of the focal length with the biological object or the background as a reference, and one focus-adjusted image is obtained through photographing with one adjustment of the focal length, and
wherein the determining the living-body detection result comprises:
counting a target quantity of comparison results indicating that the first depth-of-field information matches the second depth-of-field information in the first comparison result and a plurality of comparison results corresponding to the N focus-adjusted images; and
generating a first living-body detection result indicating a living-body detection failure if the target quantity is greater than or equal to a quantity threshold; or
generating a second living-body detection result indicating the living-body detection success if the target quantity is less than the quantity threshold.

9. The image processing method according to claim 7, wherein the focus-adjusted image comprises N first focus-adjusted images and M second focus-adjusted images, N and M each being an integer greater than 1; the N first focus-adjusted images are obtained by photographing the biological object and the background of the biological object after N first adjustments of the focal length with the biological object as a reference, and one first focus-adjusted image is obtained through photographing with one first adjustment of the focal length; and the M second focus-adjusted images are obtained by photographing the biological object and the background of the biological object after M second adjustments of the focal length with the background as a reference, and one second focus-adjusted image is obtained through photographing with one second adjustment of the focal length, and
wherein the determining the living-body detection result comprises:
determining, as a first quantity, a first quantity of comparison results that are in the comparison result corresponding to the reference image and comparison results corresponding to the N first focus-adjusted images and that indicate that the first depth-of-field information matches the second depth-of-field information;
determining, as a second quantity, a second quantity of comparison results that are in the comparison result corresponding to the reference image and comparison results corresponding to the M second focus-adjusted images and that indicate that the first depth-of-field information matches the second depth-of-field information;
calculating a comprehensive quantity according to the first quantity and the second quantity; and
generating a first living-body detection result indicating a living-body detection failure if the comprehensive quantity is greater than or equal to a quantity threshold; or
generating a second living-body detection result indicating the living-body detection success if the comprehensive quantity is less than the quantity threshold.

10. The image processing method according to claim 1, further comprising at least one of:
performing matching detection on the photographed image with registered images in the biological registry based on the living-body detection result of the biological object indicating the living-body detection success, and determining that authentication on the biological object succeeds based on a registered image of the biological object matching the photographed image being detected; or
performing matching detection on the biometric feature of the biological object in the photographed image with a plurality of registered biometric features in the biological registry based on the living-body detection result of the biological object indicating the living-body detection success, and determining that authentication on the biological object succeeds based on a registered biometric feature of the biological object matching the biometric feature in the photographed image being detected.

11. An image processing apparatus, comprising:
at least one memory configured to store computer program code; and
at least one processor configured to read the program code and operate as instructed by the program code, the program code comprising:
obtaining code configured to cause at least one of the at least one processor to photograph a biological object to be detected in a living-body detection scenario, and a background of the biological object to obtain a photographed image; and
first processing code configured to cause at least one of the at least one processor to perform depth-of-field analysis on the photographed image, to obtain first depth-of-field information of the biological object and second depth-of-field information of the background;
second processing code configured to cause at least one of the at least one processor to compare the first depth-of-field information with the second depth-of-field information, to obtain a comparison result;
third processing code configured to cause at least one of the at least one processor to determine, based on the comparison result, a living-body detection result indicating whether the biological object in the living-body detection scenario is a real living object; and
registry code configured to cause at least one of the at least one processor to perform at least one of:
store the photographed image into a biological registry if the living-body detection result of the biological object indicates a living-body detection success; or
extract a biometric feature of the biological object in the photographed image and storing the biometric feature into the biological registry, if the living-body detection result of the biological object indicates the living-body detection success.

12. The image processing apparatus according to claim 11, wherein the first processing code is configured to cause at least one of the at least one processor to:
determine, in the photographed image, a biological region image corresponding to the biological object and a background region image corresponding to the background;
determine image blurriness of the biological region image, and determining the image blurriness of the biological region image as the first depth-of-field information; and
determine image blurriness of the background region image, and determining the image blurriness of the background region image as the second depth-of-field information.

13. The image processing apparatus according to claim 12, wherein the first processing code is configured to cause at least one of the at least one processor to:
perform skeleton analysis on the biological object in the photographed image to obtain skeleton information of the biological object;
determine the biological region image in the photographed image according to the skeleton information of the biological object; and
determine the background region image in the photographed image according to the skeleton information of the biological object.

14. The image processing apparatus according to claim 13, wherein the biological object is a hand, and
wherein the first processing code is configured to cause at least one of the at least one processor to perform at least one of:
determine, based on the skeleton information of the biological object comprising first position information of finger skeleton points in the photographed image, a finger region image in the photographed image according to the first position information, and determining the finger region image as the biological region image;
determine, based on the skeleton information of the biological object comprising second position information of full-hand skeleton points in the photographed image, a full-hand region image in the photographed image according to the second position information, and determining the full-hand region image as the biological region image; or
determine, based on the skeleton information of the biological object comprising third position information of palm skeleton points in the photographed image, a palm region image in the photographed image according to the third position information, and determining the palm region image as the biological region image.

15. The image processing apparatus according to claim 14, wherein the first processing code is configured to cause at least one of the at least one processor to perform at least one of:
determine, based on the skeleton information of the biological object further comprising fourth position information of purlicue skeleton points in the photographed image, a purlicue region image in the photographed image according to the fourth position information, and determining the purlicue region image as the background region image; or
determine, based on the skeleton information of the biological object further comprising fifth position information of a plurality of hand boundary skeleton points in the photographed image, a hand boundary region image in the photographed image according to the fifth position information and sixth position information of an image boundary of the photographed image, and determining the hand boundary region image as the background region image.

16. The image processing apparatus according to claim 12, wherein the first processing code is configured to cause at least one of the at least one processor to:
obtain a Laplacian template;
perform convolution processing on the biological region image by using the Laplacian template to obtain a convolutional image of the biological region image; and
perform statistical calculation on pixel values of a plurality of pixels in the convolutional image of the biological region image to obtain the image blurriness of the biological region image.

17. The image processing apparatus according to claim 11, wherein the photographed image comprises a reference image and a focus-adjusted image, the reference image being obtained by photographing the biological object and the background of the biological object according to a reference focal length, and the focus-adjusted image being obtained by photographing the biological object and the background of the biological object after a focal length is adjusted,
wherein the comparison result comprises a first comparison result corresponding to the reference image and a second comparison result corresponding to the focus-adjusted image; and the first comparison result is obtained by comparing the first depth-of-field information and the second depth-of-field information in a first depth-of-field analysis result of the reference image,
wherein the second comparison result is obtained by comparing the first depth-of-field information and the second depth-of-field information in a second depth-of-field analysis result of the focus-adjusted image, and
wherein the third processing code is configured to cause at least one of the at least one processor to:
determining the living-body detection result of the biological object according to the first comparison result and the second comparison result.

18. The image processing apparatus according to claim 17, wherein a quantity of focus-adjusted images is N, N being an integer greater than 1; and N focus-adjusted images are obtained by photographing the biological object and the background of the biological object after N adjustments of the focal length with the biological object or the background as a reference, and one focus-adjusted image is obtained through photographing with one adjustment of the focal length, and
wherein the third processing code is configured to cause at least one of the at least one processor to:
counting a target quantity of comparison results indicating that the first depth-of-field information matches the second depth-of-field information in the first comparison result and a plurality of comparison results corresponding to the N focus-adjusted images; and
generating a first living-body detection result indicating a living-body detection failure if the target quantity is greater than or equal to a quantity threshold; or
generating a second living-body detection result indicating the living-body detection success if the target quantity is less than the quantity threshold.

19. The image processing apparatus according to claim 17, wherein the focus-adjusted image comprises N first focus-adjusted images and M second focus-adjusted images, N and M each being an integer greater than 1; the N first focus-adjusted images are obtained by photographing the biological object and the background of the biological object after N first adjustments of the focal length with the biological object as a reference, and one first focus-adjusted image is obtained through photographing with one first adjustment of the focal length; and the M second focus-adjusted images are obtained by photographing the biological object and the background of the biological object after M second adjustments of the focal length with the background as a reference, and one second focus-adjusted image is obtained through photographing with one second adjustment of the focal length, and
wherein the third processing code configured to cause at least one of the at least one processor to:
determining, as a first quantity, a first quantity of comparison results that are in the comparison result corresponding to the reference image and comparison results corresponding to the N first focus-adjusted images and that indicate that the first depth-of-field information matches the second depth-of-field information;
determining, as a second quantity, a second quantity of comparison results that are in the comparison result corresponding to the reference image and comparison results corresponding to the M second focus-adjusted images and that indicate that the first depth-of-field information matches the second depth-of-field information;
calculating a comprehensive quantity according to the first quantity and the second quantity; and
generating a first living-body detection result indicating a living-body detection failure if the comprehensive quantity is greater than or equal to a quantity threshold; or
generating a second living-body detection result indicating the living-body detection success if the comprehensive quantity is less than the quantity threshold.

20. A non-transitory computer-readable storage medium, storing computer code which, when executed by at least one processor, causes the at least one processor to at least:
photograph a biological object to be detected in a living-body detection scenario, and a background of the biological object to obtain a photographed image; and
perform depth-of-field analysis on the photographed image, to obtain first depth-of-field information of the biological object and second depth-of-field information of the background;
compare the first depth-of-field information with the second depth-of-field information, to obtain a comparison result;
determine, based on the comparison result, a living-body detection result indicating whether the biological object in the living-body detection scenario is a real living object; and
perform at least one of:
store the photographed image into a biological registry if the living-body detection result of the biological object indicates a living-body detection success; or
extract a biometric feature of the biological object in the photographed image and storing the biometric feature into the biological registry, if the living-body detection result of the biological object indicates the living-body detection success.
